(19) United States
(12) Patent Application Publication
(10) Pub. No.: US 2025/0061590 A1
(43) Pub. Date: Feb. 20, 2025

(54) DEFORMABLE MACHINE-READABLE MARKERS

(71) Applicant: DAWN ROBOTICS INC., Mississauga (CA)

(72) Inventors: Alan Stephen LI, Toronto (CA); Tahmeed Uzair RAHIM, Mississauga (CA)

(21) Appl. No.: 18/724,227

(22) PCT Filed: Apr. 6, 2023
(86) PCT No.: PCT/CA2023/050481

§ 371 Date: Jun. 26, 2024

Related U.S. Application Data
(60) Provisional application No. 63/328,502, filed on Apr. 7, 2022.

(51) Int. Cl. G06T 7/246; G06K 7/14

(52) U.S. Cl. CPC G06T 7/248; G06K 7/1417; G06T 2207/20072; G06T 2207/30204

(57) ABSTRACT

Embodiments herein generally relate to a method and system for detecting and using deformable machine-readable markers. In some examples, the method for detecting and using the machine-readable deformable marker, comprises: analyzing an input image frame to detect a plurality of nodes; generating a nodal connectivity graph by connecting neighboring nodes; comparing the nodal connectivity graph to a reference connectivity graph, associated with a known configuration for a deformable marker; and in response to detecting a match, identifying the deformable marker in the input image frame.

### CROSS-REFERENCE TO RELATED APPLICATIONS

The present application claims the priority benefit of U.S. Provisional Application 63/328,502, filed on Apr. 7, 2022, the entire contents of which are incorporated herein by reference.

### FIELD

The present invention generally relates to machine-readable markers, and in particular, to deformable machine-readable markers and methods for detecting and using thereof.

### BACKGROUND

Passive marker-based tracking is currently deployed in the motion capture industry for tracking and capturing real life three-dimensional (3D) movements of objects and people, for various applications including, inter alia, robotics, manufacturing, media, animation, AR/VR, gaming.

Fiducial markers (e.g., AprilTags and Quick Response (QR) codes) are examples of passive marker-based tracking. Fiducial markers often include two-dimensional (2D) patterns that are rigidly attached to an object of interest, and calibrated to a model of the object such that motion of the detected fiducial marker can be used to infer the motion of the object itself.

### SUMMARY OF VARIOUS EMBODIMENTS

In at least one broad aspect, there is provided a method for detecting and using a machine-readable deformable marker, comprising: analyzing an input image frame to detect a plurality of nodes; generating a nodal connectivity graph by connecting neighboring nodes; comparing the nodal connectivity graph to a reference connectivity graph, associated with a known configuration for a deformable marker; and in response to detecting a match, identifying the deformable marker in the input image frame.

In some embodiments, the method further comprises identifying one or more readable segments in the connectivity graph, wherein each readable segment comprises a pre-defined subset of neighboring nodes in the plurality nodes.

In some embodiments, the plurality of nodes in the deformable marker comprises a nodal arrangement.

In some embodiments, the nodal arrangement is one of a one-dimensional (1D) array, a two-dimensional (2D) array and a geometric arrangement.

In some embodiments, the nodal arrangement is a geometric arrangement, and the deformable marker includes a plurality of nodes arranged in a geometric pattern.

In some embodiments, data is encoded inside each of the plurality of geometric patterns.

In some embodiments, each readable segment comprises the same set of encoded data, defining an encoded data payload.

In some embodiments, each readable segment has a unique sequence of nodes.

In some embodiments, the input image comprises an initial input image frame, and the method further comprises using the deformable marker for motion tracking by: generating an initial mapping between the one or more readable segments and the reference marker data; receiving a subsequent image frame of the deformable marker; identifying new readable segments, in the subsequent image frame; generating an updated mapping of the new readable segments to the reference marker data; and determining motion properties of the object based on differences determined between the initial mapping and the updated mapping.

In some embodiments, method further comprises using the deformable marker for an augmented reality application by: overlaying a projectable feature over reference marker data; mapping portions of the projectable feature to reference readable segments, in the reference marker data; mapping readable segments in the input image frame, to reference readable segments in the reference marker data; and generating an updated image frame with the projectable feature applied over the object.

In another broad aspect, there is provided a system for detecting and using a machine-readable deformable marker, comprising: at least one imaging sensor; and at least one processor coupled to the imaging sensor, and configured for: analyzing an input image frame, generated by the at least one imaging sensor, to detect a plurality of nodes; generating a nodal connectivity graph by connecting neighboring nodes; comparing the nodal connectivity graph to a reference connectivity graph, associated with a known configuration for a deformable marker; and in response to detecting a match, identifying the deformable marker in the input image frame.

In some embodiments, the processor is further configured for: identifying one or more readable segments in the connectivity graph, wherein each readable segment comprises a pre-defined subset of neighboring nodes in the plurality nodes.

In some embodiments, the plurality of nodes in the deformable marker comprises a nodal arrangement.

In some embodiments, the nodal arrangement is one of a one-dimensional (1D) array, a two-dimensional (2D) array and a geometric arrangement.

In some embodiments, the nodal arrangement is a geometric arrangement, and the deformable marker includes a plurality of nodes arranged in a geometric pattern.

In some embodiments, data is encoded inside each of the plurality of geometric patterns.

In some embodiments, each readable segment comprises the same set of encoded data, defining an encoded data payload.

In some embodiments, each readable segment has a unique sequence of nodes.

In some embodiments, the input image comprises an initial input image frame, and the processor is further configured for using the deformable marker for motion tracking by: generating an initial mapping between the one or more readable segments and the reference marker data; receiving a subsequent image frame of the deformable marker; identifying new readable segments, in the subsequent image frame; generating an updated mapping of the new readable segments to the reference marker data; and determining motion properties of the object based on differences determined between the initial mapping and the updated mapping.

In some embodiments, the processor is further configured for using the deformable marker for an augmented reality application by: overlaying a projectable feature over reference marker data; mapping portions of the projectable feature to reference readable segments, in the reference marker data; mapping readable segments in the input image frame, to reference readable segments in the reference marker data; and generating an updated image frame with the projectable feature applied over the object.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 illustrates an environment that includes an example deformable machine-readable marker.

FIG. 2A is an image of an example deformable marker applied to a mail package.

FIG. 2B is an image of an example deformable marker applied to a pillow, and further, showing one or more images projected onto the pillow, in an augmented reality space.

FIG. 2C is an image of an example deformable marker applied to a pillow, and further, showing images projected onto the pillow in an augmented reality space.

FIG. 3 shows a plurality of example AprilTag markers.

FIG. 4A is an example deformable marker, with a one-dimensional (1D) array of color nodes.

FIG. 4B is an example connectivity graph for the marker of FIG. 4A.

FIG. 5 illustrates an example deformable marker, with a 1D array of color nodes, applied to a rotating cylindrical object.

FIG. 6 shows various example mediums that a deformable marker may be applied over.

FIG. 7A illustrates one or more deformable markers applied around a screw driver.

FIG. 7B is an example three-dimensional (3D) reconstruction of a rotating screw driver, with applied deformable markers.

FIG. 8A is an example deformable marker, with a two-dimensional (2D) array of color nodes.

FIG. 8B is another example deformable marker, with a two-dimensional (2D) array of color nodes.

FIG. 8C is an example connectivity graph for the marker of FIG. 8A.

FIG. 9A is an example deformable marker with a geometric arrangement of color nodes.

FIG. 9B is an example readable nodal segment, extracted from the marker of FIG. 9A.

FIG. 9C is an example readable nodal segment, extracted from the marker of FIG. 9A, and showing one or more geometric arrangement of color nodes.

FIG. 10 is another example deformable marker with a geometric arrangement of color nodes.

FIG. 11A is an example deformable marker, with a geometric arrangement of color nodes, and illustrating one or more unique readable nodal segments.

FIG. 11B is an example deformable marker, with a geometric arrangement of color nodes, and illustrating one or more bytes encoded into the deformable marker.

FIG. 12A is an example method for detecting a deformable marker in an input image frame.

FIG. 12B is an example method for using a deformable maker for motion tracking.

FIG. 12C is an example method for using a deformable maker for an augmented reality application.

FIG. 12D is another example method for detecting a deformable marker.

FIG. 13A is an image of an irregular object with a deformable marker.

FIG. 13B is an image of an irregular object with a deformable marker, and overlaid with a connectivity graph

FIG. 13C is an image of an irregular object with a deformable marker, and showing a readable segment identified in the connectivity graph.

FIG. 13D is an image of an irregular object with a deformable marker, and further, with the deformable marker aligned and matched to reference marker data.

FIG. 13E shows an example initial connectivity graph segment, and one or more candidate nodes.

FIG. 13F shows an example expanded connectivity graph segment.

FIG. 14A is an example projectable image.

FIG. 14B shows the projectable image, of FIG. 14A, overlaid over reference marker data.

FIG. 14C shows the projectable image, and a deformable marker applied over an object, both overlaid over reference marker data.

FIG. 14D shows the projectable image overlaid over an image of an object.

FIGS. 15A-15C show a process for projecting an image (FIG. 15A) over a deformable marker and reference marker data (FIG. 15B), to generate augmented reality space (FIG. 15C).

FIG. 16 is an example system for detecting and using deformable markers.

FIG. 17 is an example hardware block diagram for a user device.

### DETAILED DESCRIPTION OF THE EMBODIMENTS

Embodiments herein generally relate to deformable machine-readable markers, and methods for detecting and using thereof.

### I. General Overview

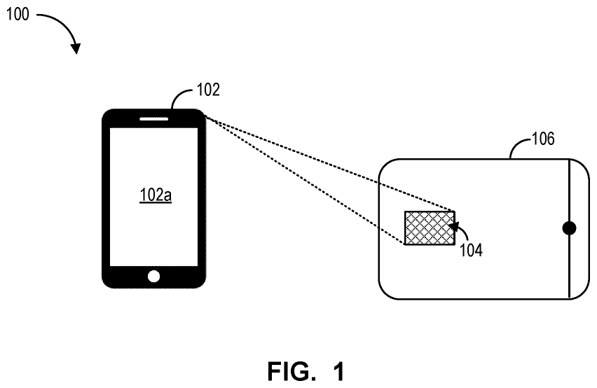

Reference is made to FIG. 1, which illustrates an environment (100) that includes a deformable machine-readable marker (104).

As shown, environment (100) includes a user device (102). User device (102) is any suitable computing device, and may include mobile devices such as smartphones, tablets or laptops. As explained herein, user device (102) can include an imaging sensor (e.g., a camera). The imaging sensor is used for capturing one or more images, or image frames, of marker (104) applied to an object (106).

As detailed herein, marker (104) can have various use applications, including: (i) encoding data and information; (ii) object detection and motion tracking; and/or (iii) augmented reality applications.

(i) Encoding Data: Marker (104) can encode data, that is extracted upon scanning of the marker (104). The encoded data can include, for example, properties of an object (106) associated with the marker (104).

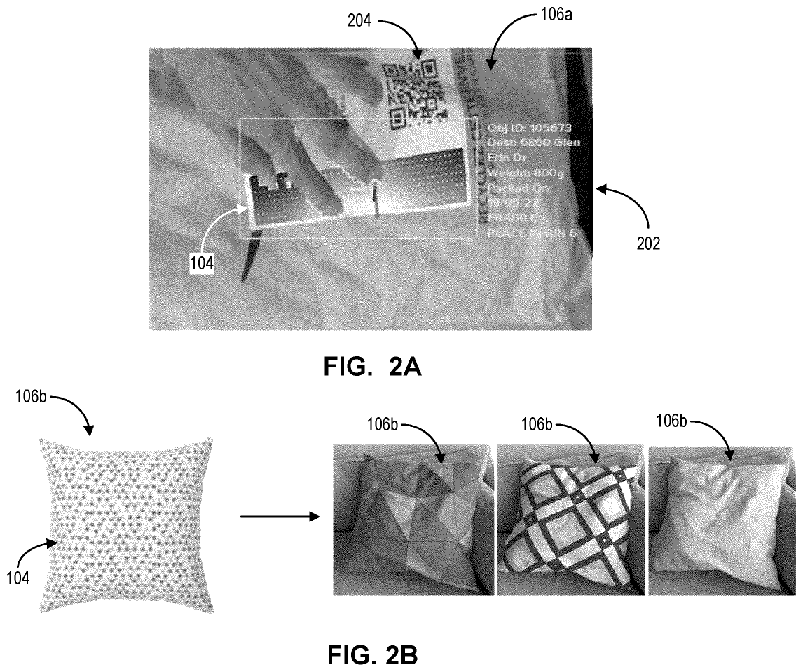

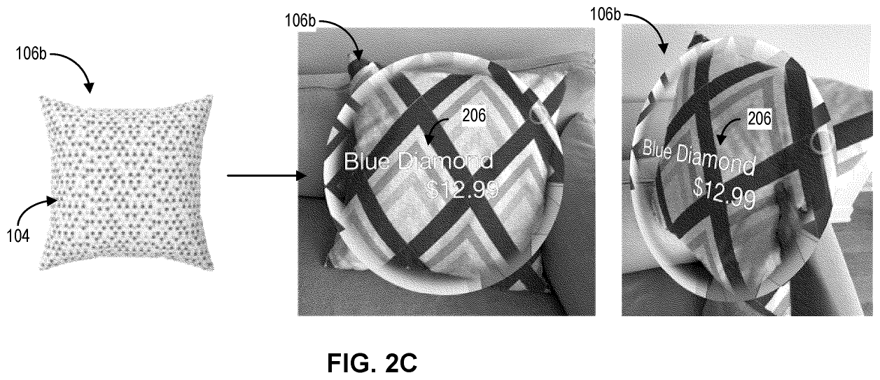

For instance, in FIGS. 1 and 2A, marker (104) is applied to a mail package (106), and the marker (104) encodes information associated with the mail package (106). By way of example, marker (104) can encode the package mailing address, sender address, etc. Accordingly, a user can scan the marker (104), via user device (102), and review information about the mail package (106).

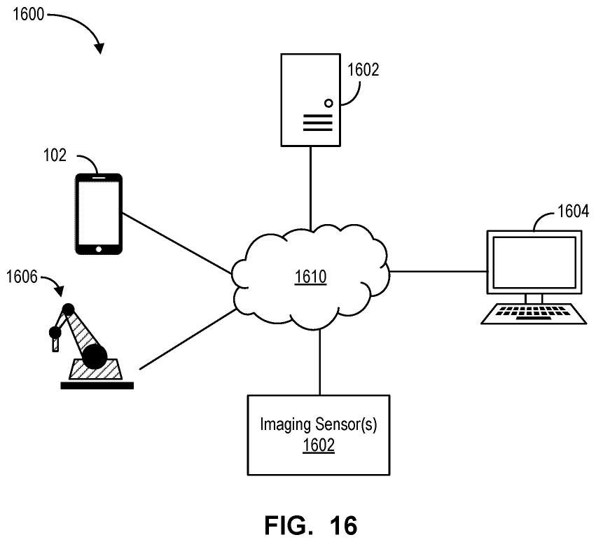

In an example automated use application, rather than scanning marker (104) via a user device (102), marker (104) is scanned using a robotic device (e.g., robotic device (1606) in FIG. 16). For instance, within a mail sorting facility, an automatic mail sorter scans the marker (104) to extract (i.e., decode) information about the mail package, as well as handling instructions. This information assists the robotic sorter in handling the mail package, as well as sorting the mail package. FIG. 2A shows example package information (202), encoded in an example marker (104) (e.g., ID code, weight, fragility, priority, etc.)

(ii) Object Detection and Motion Tracking: In another example application, marker (104) is used for object detection and motion tracking.

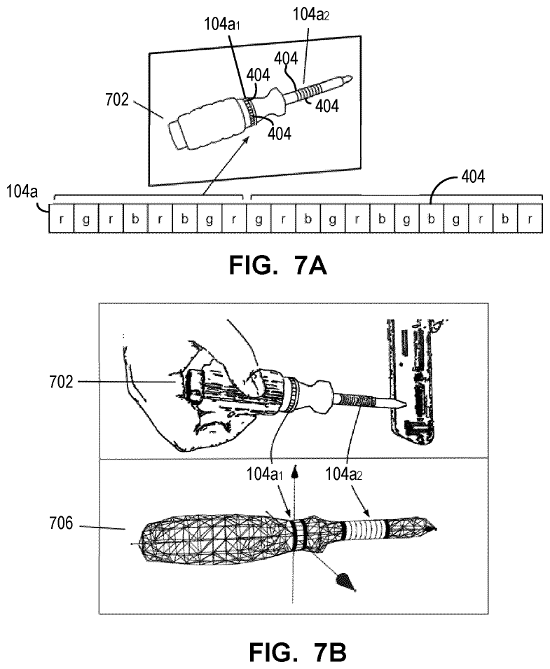

For instance, in automated applications, the presence of the marker (104) enables object (106) detection and localization by a robotic device. For example, an automatic mail sorter can identify the presence of a mail package (106), via the detected marker (104). Marker (104) can also act as a fiducial marker, to track object motion. The tracked object motion can include translation, rotation and/or tilting motion. By way of example, as explained with reference to FIGS. 7A and 7B, marker (104) can be applied around a screw driver, and can track rotation of the screw driver. In at least one example, the motion tracking enables a 3D reconstruction of the moving object.

To that end, motion tracking, along with reconstruction, allows the disclosed marker (104) to be used in a wide variety of applications such as robotics, smart packaging, AR/VR, low cost motion capture, game animation development, manufacturing automation and other such areas which require motion capture.

(iii) Augmented Reality (AR) Applications: Still further, marker (104) is also useful for AR applications. For instance, marker (104) can act as a “green screen” to project images and/or text features.

For example, in FIG. 2B, the marker (104) is applied over a pillow (106b). A user, using the user device (102), can capture an image of the pillow (106b), with the applied marker (104). In turn, the user device (102) displays—e.g., on display interface (102a) (FIG. 1)—an image, projected onto the area of the pillow (106b), covered by the marker (104).

In this manner, a user is able to view the pillow (106b) with different textures (see images in FIG. 2B). That is, different pillow designs are viewable—in real-time, or near real-time-without each pillow design being necessarily available in the real world. The same concept can apply for post-production editing for brand or ad customization of objects, using the marker (104).

More generally, marker (104) can be used for more than one of the above-noted applications, concurrently, e.g., (i) encoding data and information; (ii) motion tracking; and/or (iii) augmented reality applications.

FIG. 2C shows an example where all three use applications are applied concurrently. In this example, marker (104) encodes data enabling access to an image, to be projected over pillow (106b). For example, marker (104) can encode a Uniform Resource Locator (URL), that upon scanning, enables the user device (102) to automatically retrieve and/or download a projectable image (e.g., via the internet). As shown, the image can comprise a texture to be applied over the pillow (106b) (e.g., a “blue diamond” texture). The encoded URL can also allow access to other object information (206), such as the texture type and price.

As shown, the textured image is applied to the pillow (106b), to provide an augmented reality experience. The object information (202) is also projected adjacent, or over, the pillow (106b), for the benefit of the user.

In this example, motion of the pillow (106b) is further tracked to ensure that the projected image and/or text correctly tracks translation, rotation or tilting of pillow (106b).

While not explicitly illustrated, it is possible to apply different markers (104) to different surfaces. In these examples, for each marker, the user device (102) can separately and concurrently: (i) extract encoded data; (ii) track motion of an object associated with that marker (104); and/or (iii) project different image or text features onto that marker (104).

A unique feature of the marker (104), is that the marker (104) is machine-readable, notwithstanding that fact that it is applied to non-planar, or non-flat surfaces. In other words, the marker (104) can withstand heavy deformations, and remain machine-readable. In this manner, marker (104) is also referred to herein as a “deformable” marker (104).

As used herein, machine-readable refers to the fact that the deformable marker (104) can be detected and/or used for (i) encoding data and information; (ii) object detection and motion tracking; and/or (iii) augmented reality applications, notwithstanding deformation of the marker (e.g., the marker is not on a flat or planar surface, and/or is otherwise twisted, folded, etc.). That is, the entirety of the marker is still detectable and usable, without any significant degradation in detectability and usefulness, and notwithstanding deformation.

For example, in FIG. 2A, the deformable marker (104) is machine-readable, notwithstanding heavy deformation of the mail package (104). By a similar token, in FIG. 2B, the marker (104) is machine-readable, notwithstanding being applied to heavily deformed or irregular surfaces, such as pillows (FIG. 2B), T-shirts or the like.

This is contrasted to existing image-based markers, which are unreadable by a computer in a deformed state. This includes fiducial markers using two-dimensional (2D) binary matrices (e.g., QR codes and AprilTags), which require a large, flat surface for proper detection (e.g., QR code (204) in FIG. 2A). As a result, tracking small, curved and/or deformable objects, using these conventional markers, is not possible without making attachments or modifications to the object shape.

Additionally, the disclosed marker (104) is also machine-readable, notwithstanding having occlusion. That is, portions of the marker (104) can be blocked and/or out-of-view, without preventing detection of the marker (104). In contrast, current fiducial markers require the entire marker to be visible. For example, in order to use QR codes or AprilTags, the entire QR code or AprilTag must be visible with the camera's image frame.

### II. Machine-Readable Deformable Marker

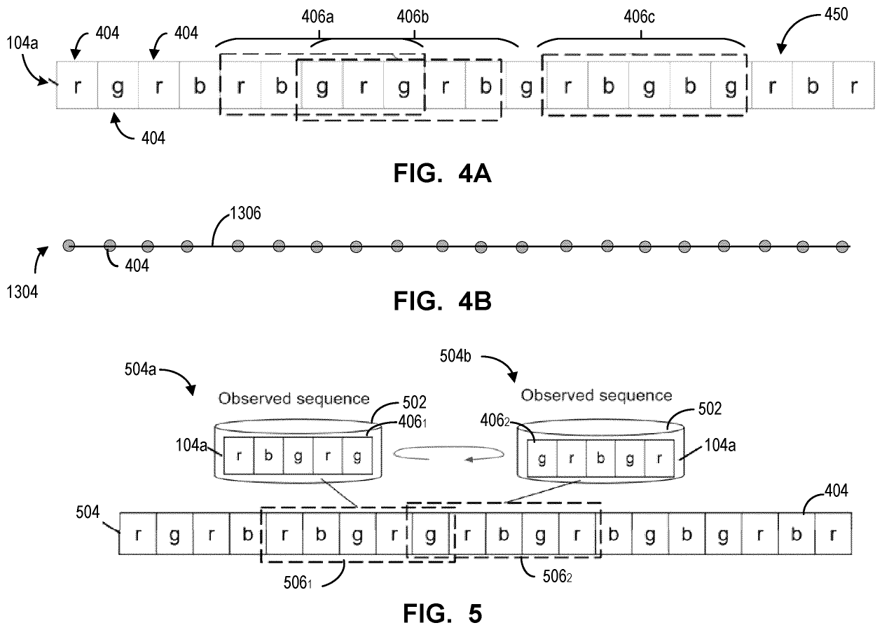

Reference is now made to FIGS. 4A, 8A and 9A-9C, which show example embodiments of a deformable marker (104).

As shown, the disclosed deformable marker (104) includes a sequenced arrangement of nodes (404), each having a node-specific fill. As used herein, a node refers to a continuous area or block of a uniform fill type.

To that end, the deformable marker (104) can include nodes with different fill types. In some examples, the deformable marker (104) includes nodes with a color fill type. For instance, each node can have one of a red (r), green (g) or blue (b) color fill. The nodes can also have different, pre-defined gradients (or frequencies) of the same color fill (e.g., bright red, dark red or medium hue red).

In other examples, the deformable marker (104) can include nodes with a grey-scale fill. For example, each node can have a node-specific grey hue. In some examples, each node can simply have a fill comprising one of white, black or an intermediate grey fill.

In still other examples, the fills are selected from a set of pre-defined patterns (e.g., hatches, vertical lines, horizontal lines, etc.).

For sake of explanation, the remaining discussion will reference nodes having a colored fill (e.g., also known as color nodes), however it will be understood that different deformable markers can include nodes with different fill types (e.g., patterned fills).

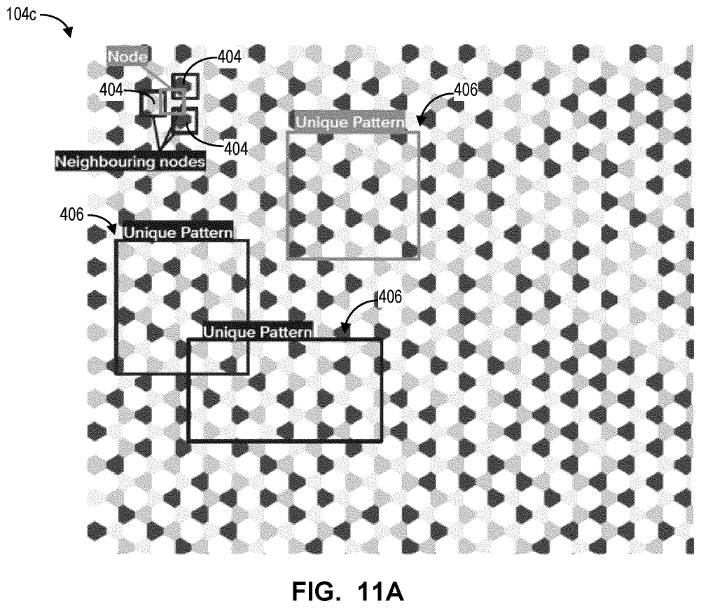

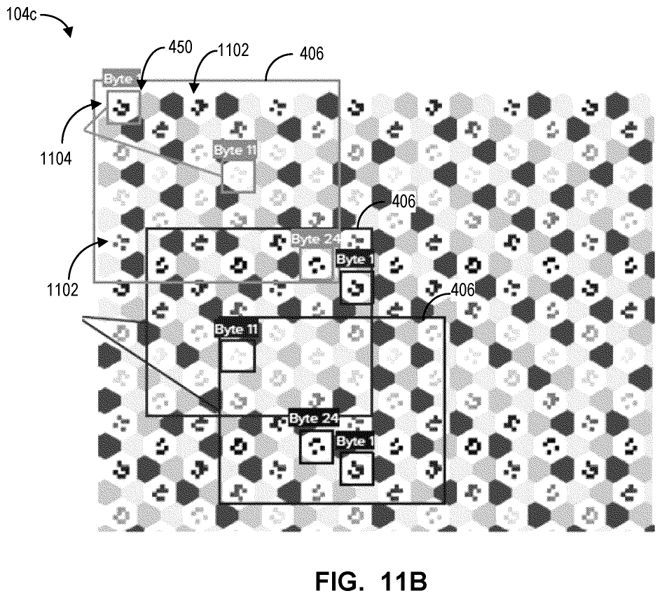

Nodes (404) can further have any desirable properties. For example, the nodes (404) can have any pre-defined shape properties, including rectangular shapes (FIG. 4A), or otherwise, hexagonal shapes (FIG. 11A), circular shapes (FIG. 10), triangular shapes, or the like.

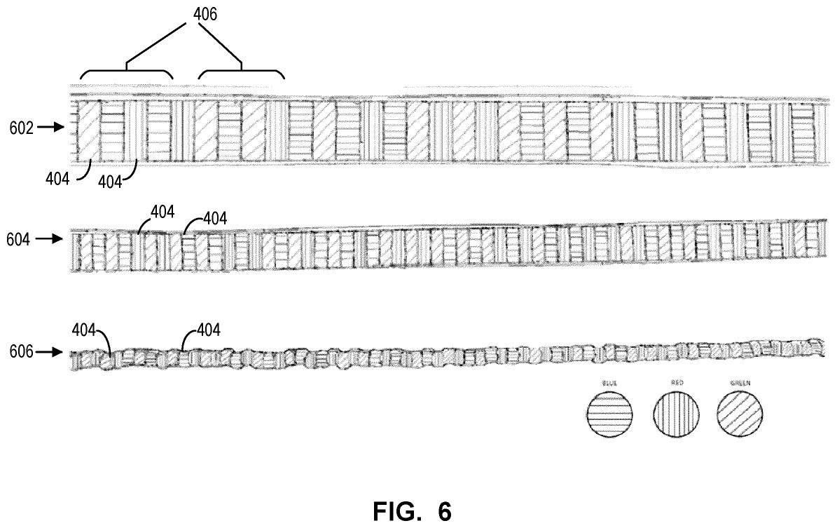

Nodes (404) can also have any suitable dimension properties. For instance, a rectangular node (404) can have any suitable pre-defined height (H)×width (W) dimensions (FIG. 6). Similarly, circular nodes (404) could have any pre-defined diametrical properties.

The properties of the nodes (404) can be uniform over the entire marker (104), or may be variable.

As shown in FIG. 6, the deformable marker (104) can be used with various mediums. For example, the marker (104) can be used with printed material (602), tape (604), and/or threads (606). In turn, these mediums can be applied over objects of interest (e.g., a mail package).

As shown in FIG. 5, irrespective of the medium used, the deformable marker (104) can be applied to various non-planar and/or deformed surfaces, while continuing to be machine-readable. For instance, as shown, the deformable marker (104) can wrap around a cylindrical object (e.g., (502) in FIG. 5).

To that end, the nodes in the deformable marker (104) are arranged with a “nodal arrangement” (450). As explained herein, the nodal arrangements (450) can be selected to be one or more of: (i) a one-dimensional (1D) array; (ii) a two-dimensional (2D) array; and/or a (iii) a geometrical pattern.

### (i) One-Dimensional (1D) Array.

As shown in FIG. 4A, the nodes in the deformable marker (104a) can be arranged with a “nodal arrangement” (450), comprising a one-dimensional (1D) array. That is, the nodes (404) are arranged in linear sequence, such that each node (404) has at least two neighboring nodes (404), i.e., excluding nodes (404) at the terminal ends. Each node (404) may be contiguous with its neighboring nodes (404), or otherwise, spaced apart.

In the exemplified embodiment, each sequence of five neighboring nodes (404), defines a “readable nodal segment” (406) (or simply, a “readable segment”). In other examples, the readable segments (406) are defined to have any other pre-defined number of neighboring nodes (e.g., 3, 4, 6, 7, etc.). As used herein, neighboring nodes are nodes which are directly adjacent to one another, without the presence of any other intermediary nodes in-between. In some examples, a straight line can be drawn between the two neighboring nodes, without the line intersecting any third node.

Significantly, each readable segment (406) is configured to be unique from any other readable segment (406), in deformable marker (104a). That is, each readable segment (406) has a unique ordered sequence of node (404) fill, that is not replicated in any other readable segment (406) (e.g., a unique segment-specific color sequence, or a unique segment-specific pattern sequence).

For example, in FIG. 4A, node segment (406a) has a unique ordered color sequence, which is different and unique from any other “overlapping” readable segment (406b), or otherwise, any other “non-overlapping” readable segment (406c). In some examples, the node sequence, for a readable segment, is unique even when the sequences are observed in reverse order.

It is appreciated that the number of unique readable segments (406) increases as a function of available node colors (or other fill types). That is, if the marker (104a) includes a greater diversity of available node colors that can be selected, they can be sequenced to generate a greater range of unique readable segments (406). According to some examples, the deformable marker (104a) includes at least three types of color nodes (e.g., r,g,b) to generate enough available unique readable segments (406). In other examples, the marker includes nodes with at least three different patterns, i.e., for pattern-filled nodes.

In at least one example application, the unique readable segments (406) are used for object tracking. For instance, in an automated use case, a robot captures an image frame of the surrounding environment, and can localize the position of an object (e.g., object (502) in FIG. 5) in the image by identifying a known readable segment (406) of color nodes (e.g., FIG. 2A). This known readable segment (406) indicates the presence of a deformable marker (104a) in the captured image frame.

In another example application, the unique readable segments (406) can facilitate motion tracking. For example, FIG. 5 depicts a view of the cylindrical object (502), wrapped with the deformable marker (104a). Depending on rotation of the object (502), different readable segments (406) are visible in different image frames captured by a camera.

For instance, in a first position (504a), a first readable segment (4061) is visible in the image frame. In a second rotated position (504b), a second unique readable segment (4062) is now visible in the image frame. Accordingly, motion tracking is enabled by tracking which readable segment (406) is located within the image frame.

In particular, as shown in FIG. 5, the system can store pre-defined reference marker data (504). The reference data (504) stores the known ordered sequence and arrangement of nodes, in the deformable marker (104a).

To enable motion tracking, the system matches the imaged segments (4061), (4062) to the corresponding reference segments (5061), (5062). In this example, it is observed that the second reference segment (5062) is shifted right, by four color nodes, relative to the first reference segment (5061).

If the system is informed that the marker (104a) is applied to a cylindrical object, the system can apply motion tracking by correlating the right shift, by four nodes, to a clockwise rotation of the object (502).

Further, if the deformable marker (104) is wrapped around the entire 360° circumference of object (502), the system may also determine—not only the direction of rotation—but also, the extent of rotation. For example, based on the number of nodes (404) in the marker (104a) (e.g., 20 nodes in FIG. 5), and the known spacing between the nodes (404)—the system can determine that a right shift, of four nodes, corresponds to a clockwise rotation of 72°.

Importantly, the motion tracking is enabled, even if the marker (104a) is deformed and applied over a non-planar surface. This is because, as explained below, the marker (104a) is identified and tracked at the pixel, or node level. Insofar as the system is able to identify a sequence of neighboring nodes—e.g., forming a readable segment (406)—it is immaterial if the marker (104) is applied to a flat or deformed surface.

Additionally, it is not necessary that the entire deformable marker (104a) be visible in the image frame to enable motion tracking-only the minimum number of color nodes (404) forming a single readable segment (406), should be visible (e.g., five color nodes). This means motion tracking is enabled, even if a portion of the marker (104a) is occluded from view.

In some examples, even if the image frame includes a partial readable segment (406) (e.g., four nodes rather than five nodes), a match can be found with a set of possible positions in the original sequence (504), and further narrowed with additional information from previous detections, such as object speed, to identify the most likely match.

To that end, FIG. 7A depicts an example motion tracking application, using the deformable marker (104a). In this example, one or more marker (104a₁), (104a₂) are applied to a screwdriver (702). In the case of marker (104a₂), each node (404) extends around the entire circumference of the screw driver shaft.

If a camera (e.g., of user device (102)) is oriented to face the screwdriver (702), it may capture images of the screwdriver (702) as it rotates. In the process, the camera also captures images of the deformable markers (104a), wrapped around the screw driver. The readable segments (406) are monitored to track rotation of the screw driver, as explained previously in FIG. 5.

As shown in FIG. 7B, motion tracking, using the deformable markers (104a), can enable 3D reconstruction. The fully reconstructed model (706), integrated with marker locations, is generated by continuously aligning new images of the object with previous images, through the matching of overlapping detected readable segments (406), and object features. This can be accomplished using well-established reconstruction techniques including bundle adjustment and point-cloud alignment. In some examples, the user device (102) (or a robotic device), is enabled with a 3D sensor, to generate the point cloud data. In particular, by matching segments between consecutive video frames with the reconstructed model, the motion of the object in six degrees of freedom (6-DoF) can be estimated.

### (ii) Two-Dimensional (2D) Array.

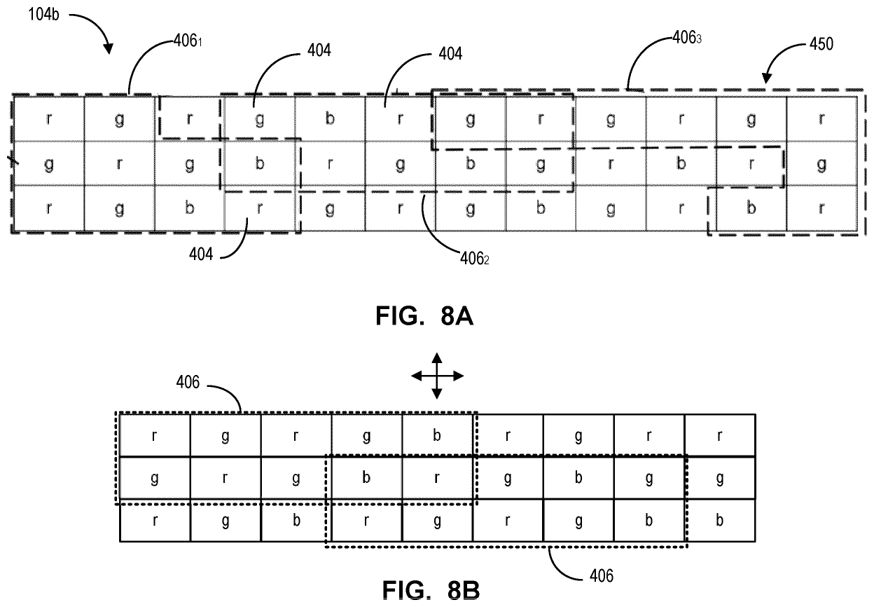

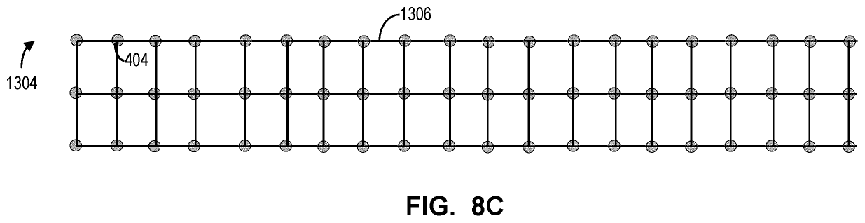

Reference is now made to FIG. 8A, which shows another example embodiment for a deformable marker (104b).

Deformable marker (104b) is generally analogous to deformable marker (104a), with the exception that it comprises a nodal arrangement (450) comprising a two-dimensional (2D) array of nodes (404).

The 2D array, in deformable marker (104b), can have any pre-defined number of columns×rows of nodes (404). As noted above, the nodes (404) are not limited to any particular pre-defined size or shape. Further, neighboring nodes (404) can be contiguous, or otherwise, spaced apart.

In this example, each unique readable segment (406) can includes a sub-set of the 2D matrix array of nodes (404). That is, each readable segment (406) includes a subset of neighboring nodes (404).

The readable segments (406) can have any desirable configuration. FIG. 8A illustrates various example configurations, for defining a readable segment (406). As shown, in some examples, the readable segments (4061), (4063) can have an irregular 2D matrix arrangement of nodes. In other examples, the readable segment (4062) simply has a rectangular arrangement of nodes.

While FIG. 8A shows different example configurations for readable segments (406), in some examples, only one of these configurations is selected and used with the deformable marker (104b).

It is appreciated that an advantage of the 2D deformable marker (104b), relative to the 1D marker (104a), is that it can cover greater surfaces areas. Further, in addition to tracking motion in one dimension, it can track motion in two dimensions.

For example, as shown in FIG. 8B, as the marker (104b) shifts laterally or vertically, the readable segment (406), within an image frame, also shift. If the marker (104b) is applied to a curved surface, the marker (104b) can track, not only rotational movement of the surface, but also tilting movement.

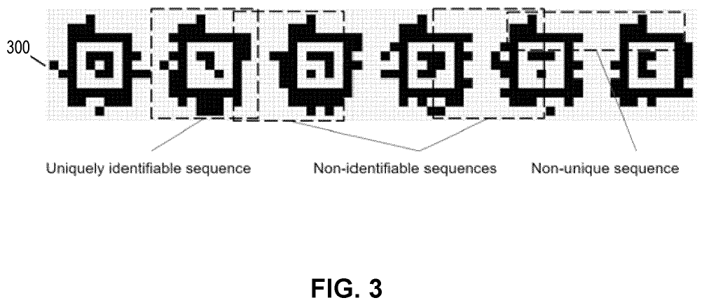

An important distinction in the 2D deformable marker (104b) as contrasted, for example, to a series of two-dimensional AprilTags (300) chained together (FIG. 3), is that the deformable marker (104b) is identified at the node level (as explained above). Whereas current fiducial markers require an entire marker to be visible for identification, the present marker only requires a readable segment to be visible.

### (iii.) Geometric Arrangements.

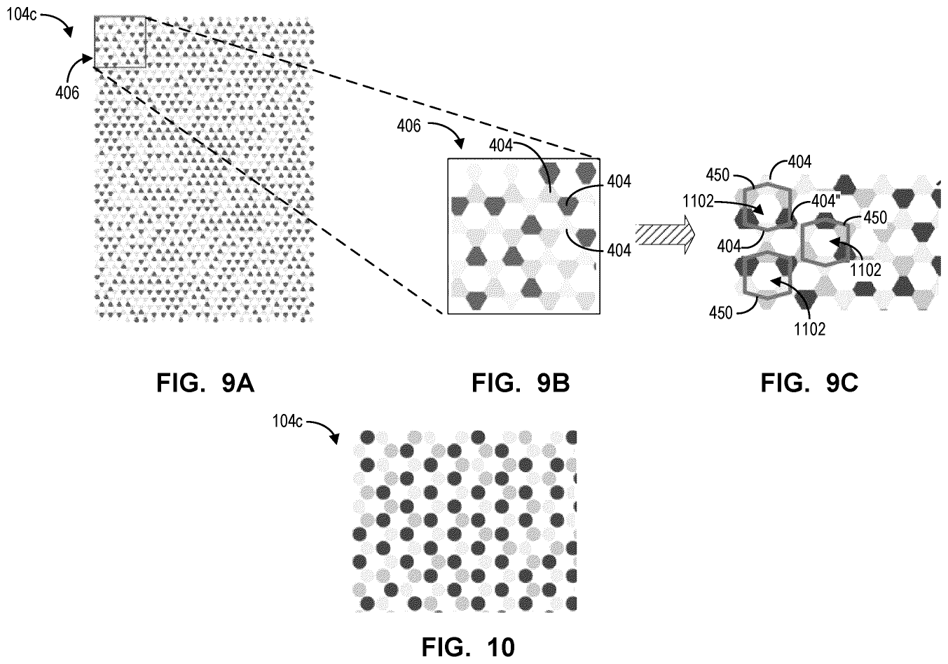

Reference is now made to FIGS. 9A-9C, which show still another example embodiment for a deformable marker (104c).

Deformable marker (104c) is generally analogous to deformable marker (104b) (FIGS. 8A and 8B), with the exception that it comprises geometric nodal arrangements (450).

For example, in FIG. 9C, each six nodes (404) are arranged to form a hexagonal arrangement (450). In other examples, the nodal arrangement (450) can include any other desirable geometric pattern of nodes (404). For example, the nodes (404) can be arranged in various regular shapes, including rectangles, triangles, octagons, etc. The nodes (404) can also be arranged in various irregular shapes. In some examples, all of the nodes (404) in a given deformable marker, have the same nodal arrangement.

Within each nodal arrangement (450), adjacent nodes (404) can be contiguous (FIG. 9C), or otherwise spaced apart (FIG. 10). Further, some (or all) nodes (404) may be part of two or more nodal arrangements (450). For example, node (404″) (FIG. 9C), is part of at least three hexagonal arrangements (450) (FIG. 9C). In some examples, all of the nodal arrangements may be contiguous to one another, as shown.

It is appreciated that, in contrast to the compact design of the 2D array marker (104b) (FIGS. 8A and 8B)—the geometric arrangement, in deformable marker (104c), allows the nodes (404) to be further spread out. In turn, this allows the deformable marker (104) to cover larger surface areas, using less nodes (404).

For example, in FIG. 2B, the deformable marker (104c) is used to cover the entire surface area of a pillow (106b), without covering each area of the pillow (106b) with a node (404). Accordingly, the deformable marker (104b) is used more efficiently, for motion tracking and augmented reality applications, and with respect to larger objects or surfaces.

Continuing reference to FIGS. 9B and 9C, in the exemplified embodiment, each readable segment (406) includes at least thirty-six (36) neighboring nodes (404) (FIG. 9B). That is, deformable marker (104c) is configured such that any set of thirty-six (36) nodes (404) forms a unique readable segment (406) (FIG. 11A). Accordingly, no two overlapping, or non-overlapping, readable segments (406) include the same ordered color sequence of nodes (404). In other embodiments, the readable segments (406) can include any other desired pre-determined number of nodes (404), insofar as each readable segment (406) has a unique node-fill sequence.

Another unique feature of the deformable marker (104c) is the ability to encode data, into the marker. For instance, as shown in FIG. 11B, additional data (1104) may be inserted and encoded in the void space (1102), formed within each geometric arrangement (450). The encoded data can include various information, such as Uniform Resource Locators (URLs), application embedding, or properties of the object the marker (104) is applied to.

As noted previously, in at least one example application, the deformable marker (104c) is applied to a mail package, and the encoded data includes information regarding the mail package (e.g., mailing address, weight, level of fragility, ID, etc.) (FIG. 2A). In automated applications, the encoded data can also include package-specific grasping methods, to allow a robotic device to engage the package.

In another example application, the deformable marker (104c) is applied to an object (e.g., a pillow), and the encoded data can include an embedded link to access various textures that can be projected onto the object. For instance, in scanning a pillow using the user device (102), the encoded data connects the user device (102) to an external URL domain (e.g., via the internet), which allows the user to download different textures to project onto the pillow.

As shown in FIG. 11B, each readable segment (406) can include the same set of encoded data. For example, in the illustrated example, each readable segment (406) includes twenty-four (24) bytes of encoded data (1104). Each byte is encoded in a separate void space (1102). The aggregate of the encoded data can form an encoded data payload.

In this manner, irrespective of which readable segment (406) is within a camera's frame, the same encoded data payload is identifiable. This avoids requiring the entire deformable marker (104c) to be visible within the image frame, to resolve the encoded data payload.

### III. Example Methods

The following is a description of various example methods for detecting and using the deformable markers (104) described herein.

### (i) General Method

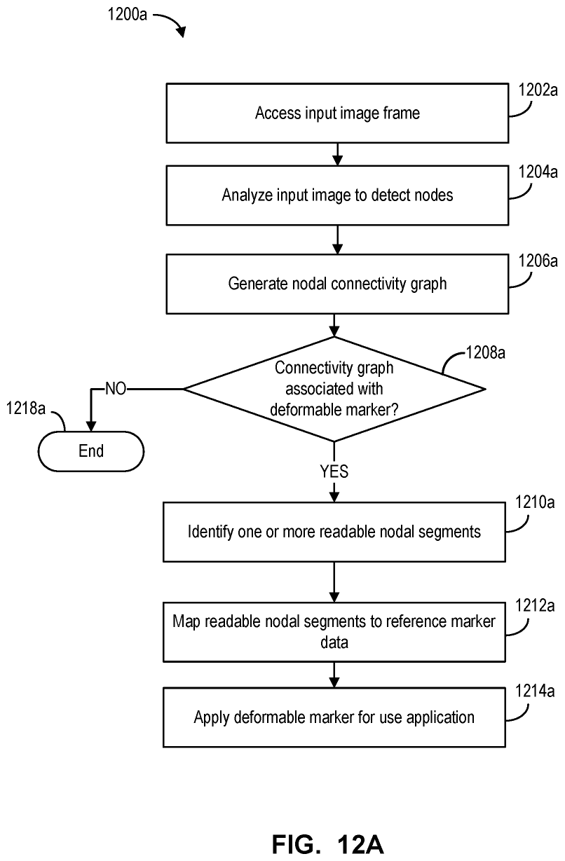

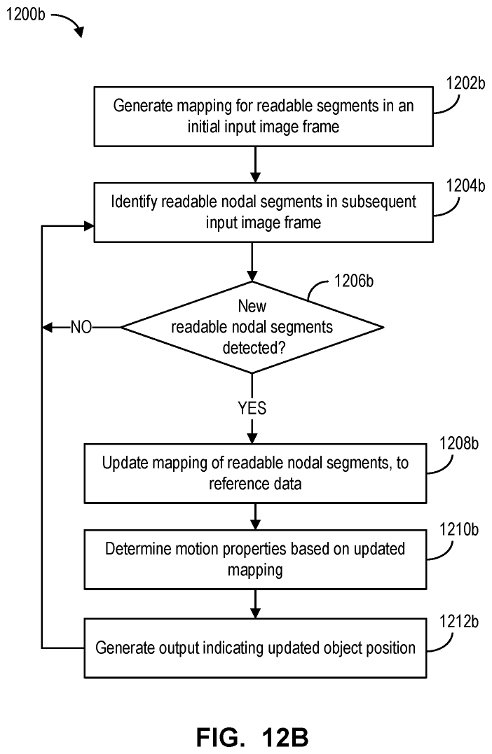

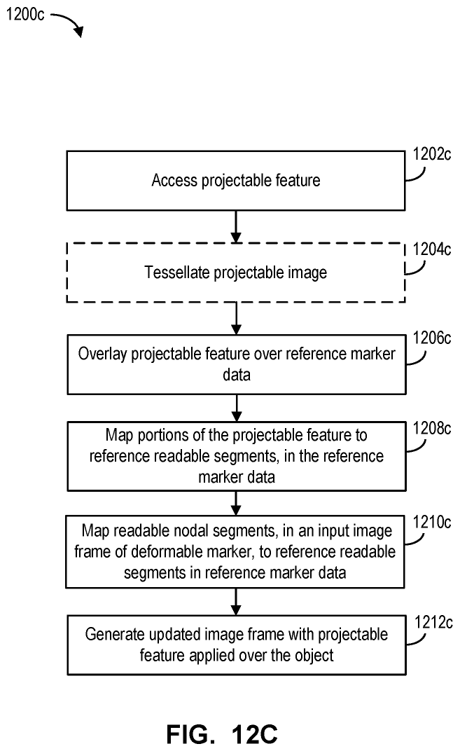

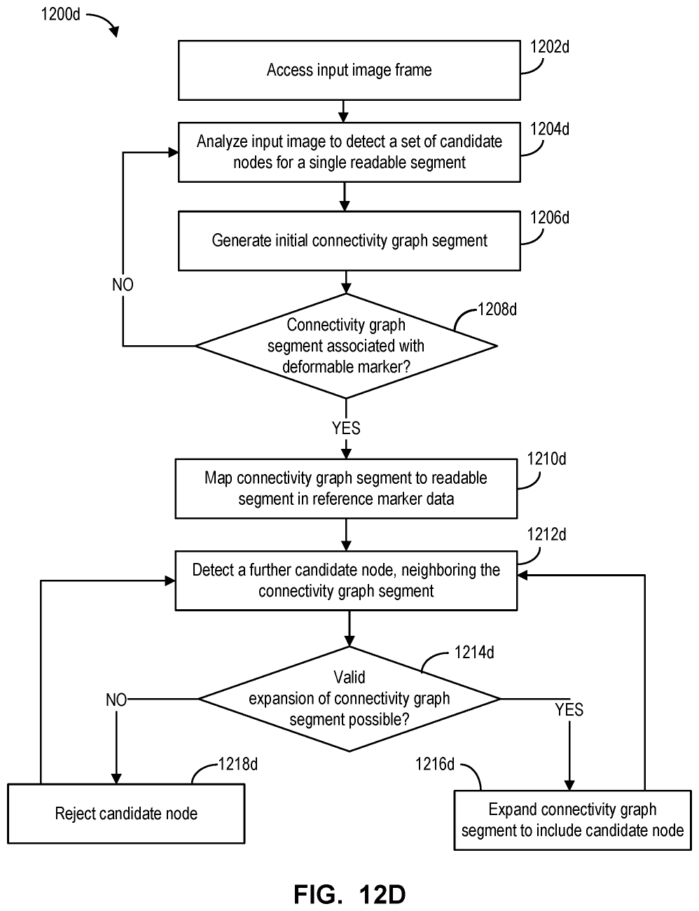

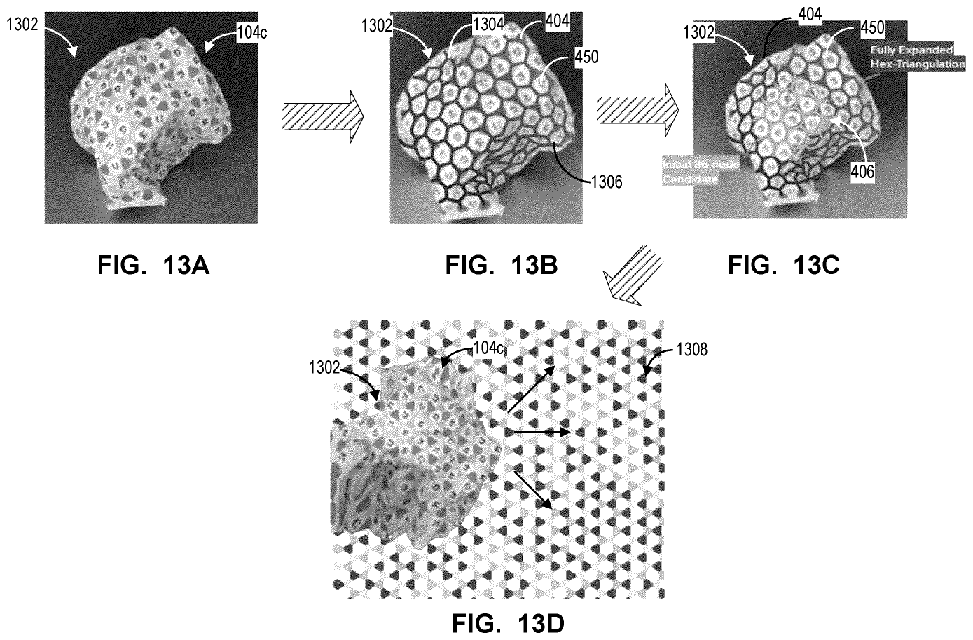

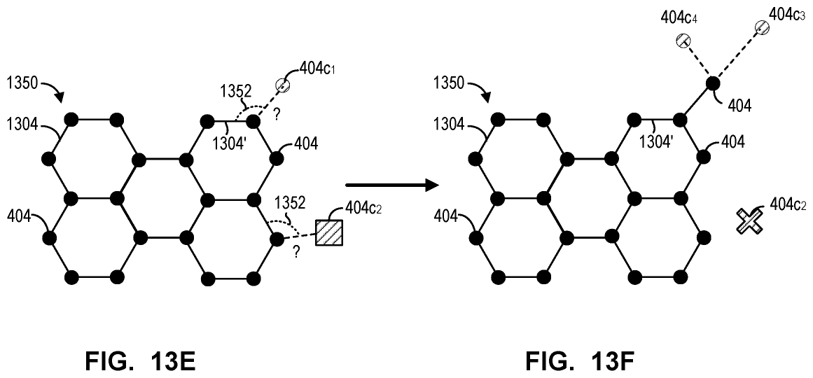

Reference is now made to FIG. 12A, which shows an example method (1200a) for detecting a deformable marker (104). In some examples, method (1200a) is executed by processor (1702) of user device (102), or otherwise, any other processor of any other computing device (e.g., a robotic device). Concurrent reference is also made to FIGS. 13A-13D.

At (1202a), an input image of a deformable marker (104) is accessed. FIG. 13A shows an example input image of a deformable marker (104c), which is applied to an object (1302). In this example, the deformable marker (104c) is characterized by a geometric nodal arrangement (FIG. 9A). In other examples, any other type of deformable marker (104) is applied to object (1302), including a 1D array deformable marker (104a) (FIG. 4A), and/or a 2D array deformable marker (104b) (FIG. 8).

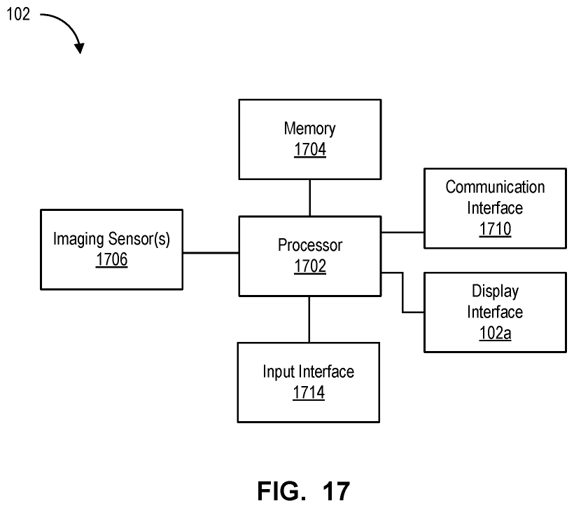

The input image may be received (i.e., accessed) by operating an imaging sensor (e.g., camera), of the user device (102). For example, this can be the imaging sensor (1706) (FIG. 17). In automated applications, an imaging sensor of a robotic device is operated to receive the input image. In other examples, the system can simply access (e.g., retrieve) a previously captured input image, i.e., from memory or a storage database.

Continuing with reference to FIG. 12A, at (1204a), the input image is analyzed to identify individual nodes (404). The identification of nodes (404) allows identifying the deformable marker (104), within the image frame.

In some examples, the system may store pre-defined node characteristics, of nodes (404) in the deformable marker (104). For example, if the deformable marker (104) uses nodes with pre-defined shapes (e.g., circular and/or rectangular nodes), pre-defined sizes, and/or pre-defined fill types (e.g color filled with one of red, green and blue color)—then each of these properties can comprise a pre-defined node characteristic. A pre-defined node characteristic can also include that the node must have a continuous block or area of uniform, or substantially uniform, fill type.

Accordingly, the system can analyze and/or search the input image frame, to identify image features (e.g., one or more pixels in the image, or otherwise a pixel region/area in the image) that match, or substantially match, one or more of the pre-defined node characteristics.

If an image feature matches all (or a minimum number) of the pre-defined node characteristics—it can be identified (e.g., labelled) by the system as a node (404), or at least a candidate node. The system can also associate the image feature with a corresponding fill property (e.g., “the image feature at pixel coordinates 540, 640 corresponds to a green color node”). The node can be identified, positionally, by its center pixel coordinate.

At (1206a), once one or more nodes are detected, a nodal connectivity graph is generated. The connectivity graph expresses how the nodes (404) are arranged relative to each other, in the deformable marker (104) (i.e., the nodal arrangement (450)).

More generally, the connectivity graph allows determining whether nodes (404) are arranged in a 1D array (FIG. 4), a 2D array (FIG. 8), or otherwise, in a geometric pattern (FIG. 9). For geometric arrangements, act (1206a) can also identify the shape of the geometric arrangement (e.g., a hexagon, octagon, etc.).

In more detail, the connectivity graph is generated by identifying, and connecting adjacent and/or neighboring nodes (404), via connection lines.

An example connectivity graph (1304) is illustrated in FIG. 13B. In this example, the connectivity graph identifies a series of hexagonal arrangements of neighboring nodes (404), connected by connection lines (1306). Each node (404), in the connectivity graph, is associated in the system with a respective fill (e.g., color), as determined at act (1204a).

By a similar token, in the examples of FIGS. 4 and 8, the connectivity graph (1302) identifies a 1D arrangement array (FIG. 4B), and/or 2D arrangement array (FIG. 8C) of neighboring nodes.

As shown in FIG. 11A, generating the connectivity graph can involve: (i) identifying a detected node (i.e., from act (1204a); (ii) determining one or more valid expansions of the connectivity graph, relative to the detected node, by identifying other detected nodes (404), which directly neighbor that node; (iii) in response to detecting a valid expansion (e.g., detecting a directly neighboring node), generating a connection line between that node and the directly neighboring node(s). The process is iterated for each node (404), until the connectivity graph is completed for all detected nodes.

At (1208a), it is determined whether the connectivity graph is associated with a known node configuration, for a deformable marker (104).

In some examples, act (1208a), involves determining whether the connectivity graph is associated with a known configuration for a 1D array (FIG. 4), 2D array (FIG. 8) or a geometric arrangement of nodes (FIG. 9).

In some examples, the system stores a database or look-up table of various pre-defined reference connectivity graphs, for different deformable markers. For example, the system can store reference connectivity graphs for 1D, 2D and/or geometric pattern markers. The system can then cross-reference, or match, the generated connectivity graph (1304), at act (1206a), to the reference database or look-up table of reference connectivity graphs.

In generating the match, the system can compare various properties of the generated and reference connectivity graphs. For example, this can include matching the shape formed by the connection lines, as well as the angles of connection lines emanating from the same node. For example, in a hexagon pattern, the connection lines emanating from a single node should be separated by a 120° angle.

As stated previously, an important aspect is that the deformable marker (104) is identified at the node level, and based on neighboring connections. This enables the marker to be identified, despite heavy deformation, insofar as the individual nodes (404), comprising a readable segment (406), are visible within an image frame.

If at act (1208a), the connectivity graph is not associated with any known deformable marker (104), the method may end. Alternatively, the method can continue searching the input image for the deformable marker (104), e.g., in other regions of the image frame. Otherwise, the method can proceed to act (1210a).

At (1210a), one or more readable segments (406) are identified, in the generated connectivity graph. For instance, in FIGS. 9B and 13C, a readable segment (406) is identified by identifying at least thirty-six directly connected nodes (404), within the connectivity graph (1304).

Similarly, in the example of FIGS. 4 and 8, the readable nodal segment (406) can include identifying a connected 1D or 2D array, comprising a pre-defined number of nodes.

To that end, the system can store pre-defined properties for a readable segment (406), for the deformable marker. For instance, these include the minimum number of connected neighboring nodes that are required to form a single readable segment (406). These properties may facilitate identifying readable segments in the connectivity graph.

At (1212a), the identified readable segments (406) are mapped to reference marker data. For example, in FIG. 5, the imaged readable segments (4061), (4062) are mapped to the reference marker data (504). This allows the system to determine which part of the global deformable marker (104a) is visible, in the image frame.

FIG. 13D shows the same concept applied to a more complex example, involving a geometric deformable marker (104c). Here, the system stores a 2D reference image (1308) of the deformable marker (104c) (e.g., similar to FIG. 9A), which is wrapped around the object (e.g., shown in the background).

As shown, the color nodes, in the imaged deformable marker (104c)—which is applied to the object (1302)—are matched and aligned to the reference marker (1308). This involves matching and aligning the readable segments (406), in the imaged marker (104c), to the corresponding unique readable segments (406), in the reference marker (1308). In some examples, this is performed by applying inverse texture mapping between the imaged deformable marker, and the reference marker. Again, this allows the system to determine which part of the deformable marker (104c) is visible, in the image frame of object (1302).

For greater clarity, in FIG. 13D, if the object (1302) is rotated to display different color nodes (404)—the deformable marker (104c) would, in turn, map/overlay to a different portion of the reference marker (1308). This is exemplified by the arrows in FIG. 13D.

Once the mapping is complete, at act (1212b), the deformable marker (104) is detected, and can be used for various applications, as explained herein. For instance, these include motion tracking, augmented reality or data decoding. In some examples, the detection is complete after act (1208a).

### (ii.) Example Application #1: Motion Tracking

Reference is now made to FIG. 12B, which shows an example method (1200b) for using a deformable marker (104) for motion tracking. That is, method (1200b) tracks motion of the object between image frames. Concurrent reference is also made to FIGS. 13A-13D.

In at least some embodiments, method (1200a) is executed by processor (1702) of user device (102), or otherwise, a processor of any other computing device (e.g., a robotic device).

As shown, at act (1202b), for an image frame of an object with a deformable marker (104)—the system identifies the visible readable segments (406) in the image frame, and generates a mapping of the readable segments (406), to reference marker data. This effectively corresponds to act (1212a), in FIG. 12A (e.g., FIG. 13D).

For example, in FIG. 5, in an initial image frame (504a), the visible readable segment (4061) is mapped to the initial reference segment (5061).

At (1204b), the system can access a subsequent image frame of the deformable marker (104). The subsequent image frame is captured after the initial image frame. In the subsequent image frame, the system again identifies any readable nodal segments (406). In effect, act (1202b) involves re-applying acts (1202a)-(1210a) of method (1200a) (FIG. 12A), for the subsequent image frame.

At (1206b), it is determined whether, for the subsequent image frame, the detected readable segments (406) are different than the readable segments (406), in the initial image frame (act (1202b)).

For example, in FIG. 5, as the object (502) rotates between a first position (504a) and a second position (504b)—the detectable readable segments (406) change between subsequent image frames. In turn, this indicates motion of the object (502), i.e., for the purpose of motion tracking.

If no new readable segments (406) are detected at act (1204b), this can indicate that the object has not moved. That is, the object is static, and therefore the same readable segments (406) are identified in subsequent image frames. In this case, the method returns to act (1202b), to continue identifying new readable segments (406) in further subsequent image frames. Otherwise, the method can proceed to act (1208b).

At act (1208b), based on the newly detected readable segments (406), the system can update its mapping of the readable segments (406), with respect to the reference marker data (e.g., act (1212a) in FIG. 12A).

For example, in FIG. 5, in the initial position (504a), the readable segment (104a) is initially mapped to a first segment (504a), in the reference marker data (504). In the subsequent rotated position (504b), act (1208b) involves updating the mapping, by mapping the new readable segment (406) to the second reference segment (504b), in the reference marker data (504).

Likewise, in FIG. 13D, as the irregular object (1302) is rotated and/or tilted, new color nodes (404) are visible in subsequent image frames. Accordingly, the visible portion of the deformable marker (104c) maps to new areas of the reference data (1308) (e.g., as shown by the arrows).

At act (1210b), the system can determine one or more motion properties of the object, based on the updated mapping.

For instance, as discussed previously—in FIG. 5, it is observed that the second reference segment (504b) is shifted right, by four nodes, from the first reference segment (504a). This indicates the direction of rotation (e.g., clockwise), as well as the extent of rotation (e.g., 72° clockwise).

Accordingly, the motion properties are determined by comparing the mapping between the initial image frame (act (1202b)), and the subsequent image frame (act (1208b)).

In more complex examples (FIG. 13D), motion can be tracked in multiple directions to allow for tracking of both tilting and rotation of an object.

At (1212b), an output is generated, indicating an updated object orientation. For example, the output can be a simple indication that the object has moved, as well as the extent and/or direction of movement. In more complex cases, the output can include generating and/or updating a 3D rendering of the object (FIG. 7B).

While method (1200b) can track object rotation and/or tilting, method (1200b) can be combined with object localization in order to track motion within six degree of freedom (6-DoF). That is, object localization can track translation of an object in different parts of an image frame, which can be combined with detected rotation/tilting of the object. The object is localized by tracking the translation/displacement of the marker (104) between different image frames.

### (iii.) Example Application #2: Augmented Reality

Reference is now made to FIG. 12C, which shows an example method (1200c) for using a deformable marker (104) for an augmented reality application.

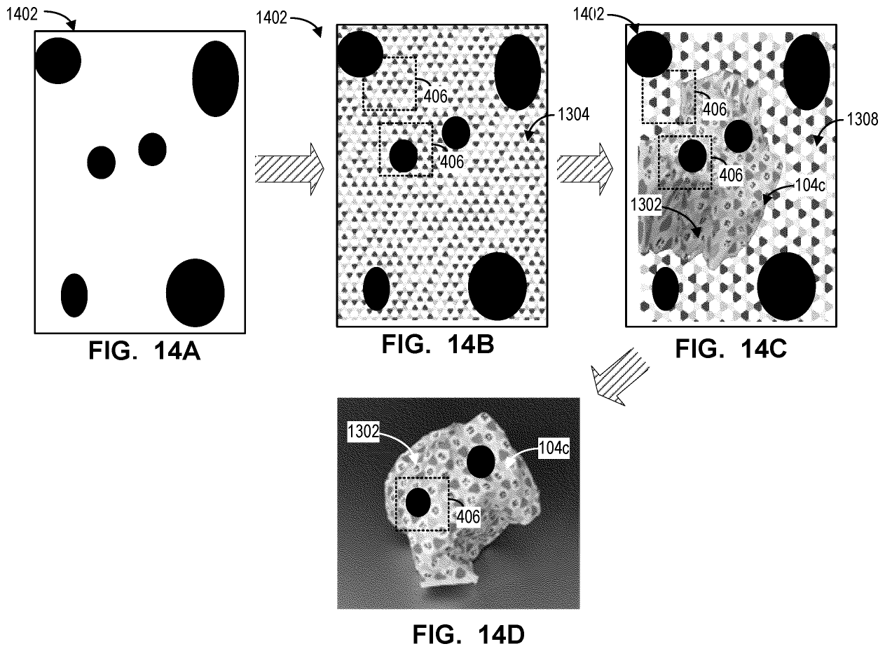

For example, as shown in FIG. 2B, the deformable marker (104) can be used to texture object surfaces (e.g., a pillow surface). Method (1200c) is another example use application of method (1200a), of FIG. 12A. Concurrent reference is also made to FIG. 14A.

In some examples, method (1200c) is executed by processor (1702) of user device (102), or otherwise, a processor of any other computing device (e.g., a robotic device).

At (1202c), the system can access an image and/or textual feature, that is desired to be projected onto a surface (referred to herein as a “projectable feature”). For example, in FIG. 2B, this corresponds to images of different pillow textures. For sake of explanation, FIG. 14A also shows a simplified projectable image (1402).

The projectable feature can be accessed from a memory or a storage database (e.g., memory (1704) of user device (102) in FIG. 17). In other examples, the projectable feature can be retrieved from an external source. For instance, the deformable marker (104) may store encoded data (FIG. 11B), which includes a URL link to retrieve and/or download the projectable feature, e.g., via the internet. Accordingly, upon scanning the deformable marker (104), the user device (102) is prompted to retrieve and/or download the projectable feature.

At (1204c), in cases where the projectable feature is an image, the projected image is tessellated to generate a tessellated images. Tessellation involves converting the projectable image into triangles for rendering.

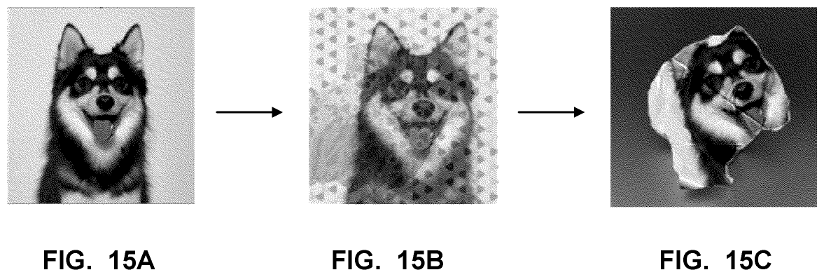

At (1206c), the projectable feature is overlaid over reference marker data. For example, as shown in FIG. 14B, the projectable image (1402) is overlaid over the reference marker data (1304). This is also shown in FIG. 15B, with reference to the projectable image in FIG. 15A.

At (1208c), in the overlaid state, different portions of the projectable feature are mapped to different reference readable segments (406), on the reference marker data. This is shown, for example, in FIGS. 14B and 15B.

At (1210c), similar to FIG. 13D, an image of the deformable marker—located on the imaged object—is also mapped to the reference marker data. This is analogous to preforming act (1212a), in FIG. 12A. This involves aligning the imaged deformable marker to the reference marker data.

An example result is shown in FIG. 14C, whereby now both the projectable image (1402), and the imaged marker (104), are mapped to the same/common reference marker data (1308). Accordingly, each readable segment, in the reference marker data, is now mapped to both (i) projectable feature/image, and (ii) the imaged object with the deformable marker (104c).

At (1210c), based on this common mapping—an updated image frame can now be generated, whereby the projectable feature is now projected over the correct readable segments (406), on the imaged deformable marker (104c), i.e., located on the object surface (see e.g., FIG. 14D). The updated image frame can be displayed, for example, on the user device's display interface (102a) (FIG. 1). This can also involve applying masking, to block or occlude parts of the projectable feature which do not align with the image object (e.g., in FIGS. 14C and 15B).

### (iii.) Example Application #3: Extracting Encoded Data

As explained previously, with reference to FIG. 11B, deformable markers (104) can also be used to encode data payloads. For example, each readable segment (406) can encode the same data payload, within the void space (1102) defined between the geometric arrangements (450). For example, each void space (1102) can encode a byte of data. Accordingly, insofar as a single readable segment (406) is visible (e.g., corresponding to 36 neighboring nodes), the data payload can be extracted and decoded.

In some examples, it is possible to decode the encoded data payload, if only portions of readable segment (406) are visible. For example, the decoding can occur where multiple disconnected detections, or partial detections from consecutive image frames of the object, can be pieced together to retrieve the full data payload.

### IV. Other Example Embodiments

The following is a description of other example embodiments for the methods and systems described herein.

### (i.) Real-Time or Near Real-Time Application.

In some examples, any one of methods (1200a)-(1200c) (FIGS. 12A-12C), can be applied in real-time or near real-time. For example, in method (1200a) (FIG. 12A), input image frames can be received from a camera in real-time or near real-time, and analyzed in real-time or near real-time, to detect deformable markers (104) in the image frames.

Similarly, in method (1200b) (FIG. 12B) and method (1200c) (FIG. 12C), the motion tracking and augmented reality applications can be applied in real-time, or near real-time, i.e., based on a real-time, or near real-time, feed of image frames.

In other examples, the methods are not performed in real-time or near real-time. For example, the methods can be applied to previously captured image frames (e.g., a previously stored video).

### (ii.) False Positive Rejection.

As discussed above, in method (1200a) of FIG. 12A, the input image is analyzed to detect image features corresponding to nodes (i.e., act (1204a)). There is a risk, however, that the system may erroneously detect image features which resemble nodes (404), but which do not in-fact form part of the deformable marker (104) (e.g., false positives).

To that end, reference is made to FIG. 12D, which shows another example method (1200d) for detecting a deformable marker (104). Method (1200d) is generally analogous to method (1200a) of FIG. 12A, but includes provisions for detecting and eliminating false positive nodes (404).

As shown, after the input image frame is accessed at (1202d), at (1204d), the input image is analyzed to detect a set of candidate nodes (e.g., potential nodes), for the deformable marker (104). This is performed in an analogous manner to act (1204a) of FIG. 12A.

In this example, the system begins by only detecting, at (1204d), enough candidate nodes to form a single candidate readable segment. In other words, if a readable segment is pre-defined as including thirty-six (36) neighboring nodes (e.g., (406) in FIG. 11A), the system can detect only an initial thirty-six candidate neighboring nodes in the image frame.

At (1206d), the system then generates a nodal connectivity graph, only for the detected candidate nodes. That is, the system will only expand the connectivity graph until it satisfies the minimum threshold for a single readable segment (e.g., (406) in FIG. 13C). This limited connectivity graph is referenced herein as a “connectivity graph segment”, or simply, a “graph segment”. The graph segment is generated in a manner analogous to act (1206a), in FIG. 12A.

At (1208d), the system can determine if the graph segment has a configuration that matches any reference connectivity graph, for any reference marker data. In other words, analogous to act (1208a) of FIG. 12A—the system can determine whether the graph segment matches any reference graphs, for any known 1D, 2D or geometric deformable markers.

If the system is unable to detect a match at (1208d), the initial candidates nodes may be deemed as false positives, and the system may search for a new set of candidate nodes at (1204d).

Otherwise, if a match is detected, it is determined that the candidate nodes do, in-fact, correspond to actual nodes associated with a deformable marker.

In this case, at (1210d), the connectivity graph segment—i.e., corresponding to a single readable segment—is mapped to the reference marker data (i.e., determined at act (1208d)). This is analogous to act (1212a) in FIG. 12A (see e.g., FIG. 13D), and involves mapping the readable segment, detected at act (1204d), to a corresponding readable segment in the reference marker data.

Once the mapping is complete, the system can now use the reference marker data for false positive rejection. This is because the reference data (e.g., FIG. 13D), now provides a reference guide for what other nodes the system should expect to locate, around the initial graph segment.

At (1212d), the system can accordingly return to analyzing the input image frame to detect further candidate nodes, which neighbor the initial graph segment.

For instance, in FIG. 13E, the system has initially identified the graph segment (1350), which includes nodes (404). As shown, this graph segment is matched, at (1208d), with a known hexagonal node arrangement, associated with hexagonal reference marker data (e.g., FIG. 9A).

Accordingly, as shown in FIG. 13E, at act (1212d), the system detects a further candidate node (404c₁), The candidate node is detected in the same manner as described previously at act (1202a) of FIG. 12A, e.g., by identifying image features that correspond to potential nodes.

At (1214d) of FIG. 12D, the system determines whether a valid expansion of the graph segment (1350) is possible, so as to include the candidate node (404c₁). That is, the system determines whether the candidate node (404c₁) is a false positive, or otherwise, is in-fact an actual node forming part of the deformable marker (104). If it forms part of the deformable marker, then the connectivity graph (1350) is validly expanded, to include the node (404c₁).

To make the determination at act (1214d), the system can determine if the candidate node (404c₁) satisfies one or more graph expansion conditions.

In some examples, the graph expansion conditions involve determining whether the candidate node (404c₁) matches the reference marker data, based on the mapping at act (1210d).

For instance, the reference marker data (e.g., FIG. 9A) can indicate that a node is expected to be found at the same position as node (404c₁), relative to the graph segment (1350). For instance, the reference data can indicate that a node is expected to found at a pre-defined angle (1352) from neighboring connection line (1304′), of graph segment (1350). In this example, as the geometric arrangement is a hexagon-node (404c₁) is expected to be orientated at a 120° angle position, from neighboring connection line (1304′), in graph segment (1350). As shown, the node (404c₁) satisfies this positional condition. In other examples, the expected positional orientation (404c₁) on of the node may not be exactly 120°, if the marker is deformed. That is, when the hexagon is applied to a curved surface, the connection lines are not separated by exactly 120° angles. In that example, the expected positional orientation of node (404c₁) may be estimated based on the determined perspective transform of the deformable marker (104).

Another example condition can be a fill condition. For example, the reference marker data (e.g., FIG. 9A), can further indicate that a node—at the positon of candidate node (404c₁)—is expected to have a green color fill. Therefore, the candidate node (404c₁) is analyzed to determine whether it has the expected green color fill. In some examples, the candidate node is automatically rejected, if it has the same fill (e.g., color) as a neighboring node, as in some embodiments, no two neighboring nodes in the deformable marker can have an identical fill, e.g., to ensure that each node is separately detectable.

Other example conditions can also include the size or shape of the node. For example, the nodes can be expected to have a pre-determined size or shape. In some examples, the system can compare the size or shape of a candidate node (404c₁), to one or more of the existing nodes (404) in graph segment (1350) to determine if the node size or shape is generally analogous. If the candidate node (404c₁), has a sufficiently different size or shape, it can be rejected as a false positive.

Accordingly, if candidate node (404c′) satisfies all (or a pre-defined minimum number) of the graph expansion conditions (e.g., position, fill, size and/or shape conditions), at act (1216d)—the connectivity graph is expanded to include the node (404c₁) as part of the deformable marker (FIG. 13F). Therefore, candidate node (404c₁) now forms an actual node in the expanded connectivity graph. The method can then return to act (1212d) to iterate in order to assess further candidate nodes, neighboring the now expanded connectivity graph (e.g., nodes (404c3) and (404c4) in FIG. 13F).

In other examples, if a candidate node does not satisfy all, or some, of the graph expansion conditions, it can be rejected at act (1218d) as a false positive.

For example, in FIGS. 13E and 13F, candidate node (404c₂) may be rejected as a false positive. This is because, while the candidate node (404c₂) appears to include characteristic features of a node, it does not otherwise satisfy the graph expansion conditions (e.g., incorrect position, fill, shape and/or size). Therefore, at act (1218d), the connectivity graph segment (1350) is not expanded to include the candidate node (404c₂). Nevertheless, the method can return to act (1212d) to continue searching for other neighboring candidate nodes.

Method (1200d) is iterated until the connectivity graph segment is expanded to include all actual detected nodes (e.g., excluding false positives).

In some examples, once the connectivity graph is generated for one image frame (e.g., via methods (1200a) and/or (1200d)), it can be used to track node positions in subsequent image frames. For example, based on the relative motion of the deformable marker on a moving object, the graph in the previous image frame can estimate the most likely area for nodes in a subsequent image frame. This can simplify the process of detecting false positives in subsequent image frames.

### (iii.) Combined Use Applications.

While the example applications in methods (1200b) and (1200c) have been described separately, these applications can also be integrated. For example, motion tracking (method (1200b)) can be used to facilitate an augmented reality experience (method (1200c)). In other words, by tracking the motion of the object using the deformable marker (104), the augmented reality experience is enhanced by ensuring that a projected feature follows motion of the deformable marker (104).

By a similar token, the decoding of encoded data, in the deformable marker (104), can also be integrated with other use applications. For example, as discussed previously, the encoded information can include a link to a projectable feature, that can be projected onto the object (e.g., a pillow), in an augmented reality space. For example, the encoded data may include information about the object, associated with the deformable marker. For instance, for a mail package, this can include the weight, size and other properties of the mail package. This information can also be augmented to be displayed with the image of the mail package (FIG. 2A).

### (iv.) Other Example System Configurations.

FIG. 16 shows another example system (1600) for detecting and using deformable markers.

As shown, the system includes the user device (102) which may be connected, via network (1610) to one or more external servers (1602) (e.g., cloud servers) and/or remote computing devices (1604). The system (1600) can also include one or more automated robotic devices (1606).

In these examples, server (1602) and/or computing device (1604) may perform all, or any portion, of the methods described herein. For example, once images are captured by the user device (102) and/or robotic device (1606), the raw or partially-processed image data is transmitted to the server (1602) and/or computing device (1604). The server (1602) and/or computing device (1604) can process the data (e.g., raw or partially processed), in accordance with the disclosed methods.

In some examples, the server (1602) and/or computing device (1604) can also return partially processed data, back to the user device (102) and/or robotic device (1606). The partially processed data is then further processed by the user device (102) and/or robotic device (1606).

The server (1602) and/or computing device (1604) can also store various data required for the described methods. For example, the server (1602) and/or computing device (1604) can store or archive various projectable features. A user device (102) can therefore access (e.g., retrieve or receive) the projectable features from the server (1602) and/or computing device (1604).

System (1600) may include imaging sensors (1602) (e.g., analogous to imaging sensors (1706) in FIG. 17). These can be included in addition to, or in alternative, to the user device (102) and/or robotic device (1606). Images captured by the sensors (1602) can be transmitted to one or more of the components in the system (1600) for processing, in accordance with the methods described herein.

In at least one example, the imaging sensors (1602) are provided in addition to the user device (102) and/or robotic device (1606). For example, this may be the case where the user device (102) and/or robotic device (1606) do not include an imaging sensor.

In still other examples, the imaging sensors (1602) are provided in alternative to the user device (102) and/or robotic device (1606). Here, it is appreciated that the disclosed methods can be performed using external imaging sensors, insofar as the system has a processor for processing the image data. For example, the output of the imaging sensors (1602) can be transmitted, via network (1610), to one of the components of system (1600) for further processing.

Communication network (1610) can be an internet, or intranet network. In some examples, network (1610) may be connected to the internet. Typically, the connection between network (1610) and the internet may be made via a firewall server (not shown). In some cases, there may be multiple links or firewalls, or both, between network (1610) and the Internet. Some organizations may operate multiple networks (1610) or virtual networks (1610), which can be internetworked or isolated. These have been omitted for ease of illustration, however it will be understood that the teachings herein can be applied to such systems. Network (1610) may be constructed from one or more computer network technologies, such as IEEE 802.3 (Ethernet), IEEE 802.11 and similar technologies.

### V. Example Hardware Configuration

Reference is made to FIG. 17, which shows an example hardware configuration for a user device (102).

As shown, the user device (102) can include a processor (1702) coupled to a memory (1704) and one or more of: (i) imaging sensor(s) (1706), (ii) communication interface (1710), (iv) display interface (102a), and/or (v) input interface (1714).

Processor (1702) includes to one or more electronic devices that is/are capable of reading and executing instructions stored on a memory to perform operations on data, which may be stored on a memory or provided in a data signal. The term “processor” includes a plurality of physically discrete, operatively connected devices despite use of the term in the singular. Non-limiting examples of processors include devices referred to as microprocessors, microcontrollers, central processing units (CPU), and digital signal processors.

Memory (1704) includes a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

Imaging sensor(s) (1706) can include any sensor for capturing two-dimensional (2D) images. For instance, this can be a camera for capturing color images (e.g., Red Green Blue (RGB) camera), grey-scale or black-and-white images.

In some examples, the imaging sensors (1706) can also include three-dimensional (3D) sensor(s) for collecting depth data. For instance, this can include any time of flight (ToF) sensor, such as a Light Detection and Ranging (LiDAR) sensor.

Communication interface (1710) may comprise a cellular modem and antenna for wireless transmission of data to the communications network.

Display interface (102a) can be an output interface for displaying data (e.g., an LCD screen).

Input interface (1714) can be any interface for receiving user inputs (e.g., a keyboard, mouse, touchscreen, etc.). In some examples, the display and input interface are one of the same (e.g., in the case of a touchscreen display).

To that end, it will be understood by those of skill in the art that references herein to user device (102) as carrying out a function or acting in a particular way imply that processor (1702) is executing instructions (e.g., a software program) stored in memory (1704) and possibly transmitting or receiving inputs and outputs via one or more interfaces.

In system (1600) (FIG. 16), the robotic device (1606), server (1602) or computing device (1604), may have an analogous architecture to user device (102).

### VI. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for detecting and using a machine-readable deformable marker, comprising:
analyzing an input image frame to detect a plurality of nodes;
generating a nodal connectivity graph by connecting neighboring nodes;
comparing the nodal connectivity graph to a reference connectivity graph, associated with a known configuration for the deformable marker; and
in response to detecting a match, identifying the deformable marker in the input image frame.

2. The method of claim 1, further comprising identifying one or more readable segments in the connectivity graph, wherein each readable segment comprises a pre-defined subset of neighboring nodes in the plurality nodes.

3. The method of claim 1, wherein the plurality of nodes in the deformable marker comprises a nodal arrangement.

4. The method of claim 3, wherein the nodal arrangement is one of a one-dimensional (1D) array, a two-dimensional (2D) array and a geometric arrangement.

5. The method of claim 4, wherein the nodal arrangement is a geometric arrangement, and the deformable marker includes a plurality of nodes arranged in a geometric pattern.

6. The method of claim 5, wherein data is encoded inside each of the plurality of geometric patterns.

7. The method of claim 6, wherein each readable segment comprises the same set of encoded data, defining an encoded data payload.

8. The method of claim 1, wherein each readable segment has a unique sequence of nodes.

9. The method of claim 2, wherein the input image frame comprises an initial input image frame, and the method further comprises using the deformable marker for motion tracking by:
generating an initial mapping between the one or more readable segments and the reference marker data;
receiving a subsequent image frame of the deformable marker;
identifying new readable segments, in the subsequent image frame;
generating an updated mapping of the new readable segments to the reference marker data; and
determining motion properties of an object based on differences determined between the initial mapping and the updated mapping.

10. The method of claim 1, wherein the method further comprises using the deformable marker for an augmented reality application by:
overlaying a projectable feature over reference marker data;
mapping portions of the projectable feature to reference readable segments, in the reference marker data;
mapping readable segments in the input image frame, to reference readable segments in the reference marker data; and
generating an updated image frame with the projectable feature applied over an object.

11. A system for detecting and using a machine-readable deformable marker, comprising:
at least one imaging sensor; and
at least one processor coupled to the imaging sensor, and configured for:
analyzing an input image frame, generated by the at least one imaging sensor, to detect a plurality of nodes;
generating a nodal connectivity graph by connecting neighboring nodes;
comparing the nodal connectivity graph to a reference connectivity graph, associated with a known configuration for the deformable marker; and
in response to detecting a match, identifying the deformable marker in the input image frame.

12. The system of claim 11, wherein the processor is further configured for: identifying one or more readable segments in the connectivity graph, wherein each readable segment comprises a pre-defined subset of neighboring nodes in the plurality nodes.

13. The system of claim 11, wherein the plurality of nodes in the deformable marker comprises a nodal arrangement.

14. The system of claim 13, wherein the nodal arrangement is one of a one-dimensional (1D) array, a two-dimensional (2D) array and a geometric arrangement.

15. The system of claim 14, wherein the nodal arrangement is a geometric arrangement, and the deformable marker includes a plurality of nodes arranged in a geometric pattern.

16. The system of claim 15, wherein data is encoded inside each of the plurality of geometric patterns.

17. The system of claim 16, wherein each readable segment comprises the same set of encoded data, defining an encoded data payload.

18. The system of claim 11, wherein each readable segment has a unique sequence of nodes.

19. The system of claim 12, wherein the input image frame comprises an initial input image frame, and the processor is further configured for using the deformable marker for motion tracking by:
generating an initial mapping between the one or more readable segments and the reference marker data;
receiving a subsequent image frame of the deformable marker;
identifying new readable segments, in the subsequent image frame;
generating an updated mapping of the new readable segments to the reference marker data; and
determining motion properties of an object based on differences determined between the initial mapping and the updated mapping.

20. The system of claim 11, wherein the processor is further configured for using the deformable marker for an augmented reality application by:
overlaying a projectable feature over reference marker data;
mapping portions of the projectable feature to reference readable segments, in the reference marker data;
mapping readable segments in the input image frame, to reference readable segments in the reference marker data; and
generating an updated image frame with the projectable feature applied over an object.
